(19) United States
(12) Patent Application Publication
(10) Pub. No.: US 2026/0017568 A1
(43) Pub. Date: Jan. 15, 2026

(54) DEVICE AND METHOD FOR GENERATING MULTI-OBJECTIVE PARETO POLICY SET

(71) Applicant: RESEARCH & BUSINESS FOUNDATION SUNGKYUNKWAN UNIVERSITY, Suwon-si (KR)

(72) Inventors: Hong Uk WOO, Suwon-si (KR); Woo Kyung KIM, Suwon-si (KR); Min Jong YOO, Suwon-si (CN)

(21) Appl. No.: 19/266,132

(22) Filed: Jul. 10, 2025

(30) Foreign Application Priority Data
Jul. 11, 2024 (KR) 10-2024-0091546

(51) Int. Cl. G06N 20/00

(52) U.S. Cl. CPC G06N 20/00

(57) ABSTRACT

An embodiment of a method for generating multi-objective Pareto policy set comprises receiving a sample dataset, generating an imitation policy and a reward function of the imitation policy from the sample dataset, setting a target policy at a predetermined position near the imitation policy, fine-tuning the target policy based on a distance between the reward function of the imitation policy and the reward function of the target policy and generating a Pareto policy set including the imitation policy and the fine-tuned target policy.

### CROSS-REFERENCE TO RELATED APPLICATIONS

This application claims the priority benefit of Korean Patent Application No. 10-2024-0091546 filed on Jul. 11, 2024 in the Korean Intellectual Property Office, the disclosures of which are incorporated herein by reference.

### BACKGROUND

### 1. Field

The present invention relates to a device and a method for generating a multi-objective Pareto policy set using inverse reinforcement learning.

### 2. Description of the Related Art

With the commercialization of artificial intelligence, various studies are being conducted to derive policies based on datasets. In particular, research is being actively conducted to derive artificial intelligence decisions for unlearned situations or to derive artificial intelligence decisions that simultaneously satisfy various objectives.

In a decision-making scenario, each expert may have his or her preference for several, possibly conflicting objectives (multi-objective). Therefore, learning Pareto optimal policies in a multi-objective environment is considered essential and practical to provide users with the ability to select a variety of expert-level policies tailored to their specific preferences. However, in the field of imitation learning, these multi-objective problems have not been sufficiently studied because they require a comprehensive expert dataset that encompasses complete multi-objective preferences. These datasets can be difficult to achieve in real-world scenarios.

In an ideal scenario, having a comprehensive expert dataset that encompasses a variety of multi-objective preferences allows you to directly derive a Pareto policy set by reconstructing policies from each dataset. However, the dataset may not represent all preferences in real-world situations. Only two distinct datasets with various multi-objective preferences can be accessed in this instance. In the case of such a limited dataset, it is an approach that may apply imitation learning to each mixed dataset after mixing these datasets in various ratios. However, this approach often has the problem of generating a non-Pareto optimal policy set.

### SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

Provided are a device and a method for generating a multi-objective Pareto policy set for calculating a Pareto policy set by fine-tuning a target policy based on a distance between an imitation policy and an approximate target policy.

An embodiment of a method for generating multi-objective Pareto policy set comprises receiving a sample dataset, generating an imitation policy and a reward function of the imitation policy from the sample dataset, setting a target policy at a predetermined position near the imitation policy, fine-tuning the target policy based on a distance between the reward function of the imitation policy and the reward function of the target policy and generating a Pareto policy set including the imitation policy and the fine-tuned target policy.

According to one embodiment, the generating an imitation policy and a reward function of the imitation policy comprises generating two imitation policies and two reward functions of the imitation policies, respectively, from each of the two sample datasets, and the setting a target policy comprises generating two target policies.

According to one embodiment, the imitation policy comprises a first imitation policy and a second imitation policy and the reward function of the imitation policy comprises a reward function of the first imitation policy and a reward function of the second imitation policy, and the fine-tuning the target policy comprises fine-tuning the target policy based on a distance between the reward function of the first imitation policy and the reward function of the target policy.

According to one embodiment, the imitation policy comprises a first imitation policy and a second imitation policy and the reward function of the imitation policy comprises a reward function of the first imitation policy and a reward function of the second imitation policy, and the fine-tuning the target policy comprises fine-tuning the target policy based on a distance between the reward function of the second imitation policy and the reward function of the target policy.

According to one embodiment, the imitation policy comprises a first imitation policy and a second imitation policy and a reward function of the imitation policy comprises a reward function of the first imitation policy and a reward function of the second imitation policy, and the fine-tuning the target policy comprises fine-tuning the target policy based on a distance between the reward function of the first imitation policy and the reward function of the second imitation policy.

According to one embodiment, the fine-tuning the target policy comprises generating a normalization term based on a distance between a reward function of the imitation policy and a reward function of the target policy and a distance between reward functions of the imitation policy, and fine-tuning the target policy by learning to maximize a reward function normalization equation including the generated normalization term.

According to one embodiment, the setting a target policy, the predetermined position is located on a predetermined Pareto front extending between the imitation policies.

According to one embodiment, the method further comprises updating the fine-tuned target policy to the imitation policy when the distance between the reward functions of the fine-tuned target policies exceeds a predetermined distance.

According to one embodiment, the generating a Pareto policy set comprises generating the Pareto policy set when a distance between reward functions of the fine-tuned target policies is equal to or less than a predetermined distance.

According to one embodiment, the generating an imitation policy and a reward function of the imitation policy and the fine-tuning of the target policy are performed based on inverse reinforcement learning.

An embodiment of a device for generating multi-objective Pareto policy set comprises an input/output interface configured to receive a sample dataset and a processor configured to generate a Pareto policy set based on the sample dataset, wherein the processor is configured to generate an imitation policy and a reward function of the imitation policy from the sample dataset, set a target policy at a predetermined position adjacent to the imitation policy, fine-tune the target policy based on a distance between the reward function of the imitation policy and the reward function of the target policy, and generate a Pareto policy set including the imitation policy and the fine-tuned target policy.

According to one embodiment, the imitation policy includes a first imitation policy and a second imitation policy, wherein the reward function includes a reward function of the first imitation policy and a reward function of the second imitation policy, and wherein the processor is further configured to fine-tune the target policy based on a distance between the reward function of the first imitation policy and the reward function of the target policy.

According to one embodiment, the imitation policy includes a first imitation policy and a second imitation policy, the reward function includes a reward function of the first imitation policy and a reward function of the second imitation policy, and the processor is further configured to fine-tune the target policy based on a distance between the reward function of the second imitation policy and the reward function of the target policy.

According to one embodiment, the imitation policy includes a first imitation policy and a second imitation policy, the reward function includes a reward function of the first imitation policy and a reward function of the second imitation policy, and the processor is further configured to fine-tune the target policy based on a distance between the reward function of the first imitation policy and the reward function of the second imitation policy.

According to one embodiment, the processor is configured to generate a normalization term based on a distance between a reward function of the imitation policy and a reward function of the target policy and a distance between reward functions of the imitation policy, and fine-tune the target policy by learning to maximize a reward function normalization equation including the generated normalization term.

According to one embodiment, the predetermined position is located on a predetermined Pareto front extending between the imitation policies.

According to one embodiment, the processor is configured to update the fine-tuned target policy to the imitation policy when the distance between the reward functions of the fine-tuned target policies exceeds a predetermined distance.

According to one embodiment, the processor is configured to generate the Pareto policy set when a distance between reward functions of the fine-tuned target policies is equal to or less than a predetermined distance.

According to one embodiment, the processor is configured to generate an imitation policy and a reward function of the imitation policy and the fine-tune the target policy by performing inverse reinforcement learning.

An embodiment of a central server for generating multi-objective Pareto policy set comprises an input/output interface configured to receive a sample dataset; and a processor configured to generate a Pareto policy set based on the sample dataset, wherein the processor is configured to generate an imitation policy and a reward function of the imitation policy from the sample dataset, set a target policy at a predetermined position adjacent to the imitation policy, fine-tune the target policy based on a distance between the reward function of the imitation policy and the reward function of the target policy, and generate a Pareto policy set including the imitation policy and the fine-tuned target policy.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram of a device for generating a Pareto policy set according to an embodiment.

FIG. 2 is a block diagram of a central server according to an embodiment.

FIGS. 3A, 3B, and 3C are block diagrams of a processor according to an embodiment.

FIG. 4 is a conceptual diagram illustrating a method of generating a Pareto policy set according to an embodiment.

FIG. 5 is a conceptual diagram illustrating a first iteration of normalizing a reward function according to an embodiment.

FIG. 6 is a conceptual diagram illustrating a second iteration of normalizing a reward function according to an embodiment.

FIG. 7 is a conceptual diagram illustrating first and second iterations of normalizing a reward function according to an embodiment of the present invention.

FIG. 8 is a diagram illustrating an algorithm for normalizing a reward function according to an embodiment.

FIGS. 9A, 9B, 9C, and 9D are conceptual diagrams illustrating a Pareto policy set generation device making driving decisions of a vehicle according to an embodiment.

FIG. 10 is a flowchart of a method for generating a Pareto policy set according to an embodiment.

FIG. 11 is a flowchart of a method of generating a Pareto policy set according to another embodiment.

Throughout the drawings and the detailed description, the same reference numerals may refer to the same, or like, elements. The drawings may not be to scale, and the relative size, proportions, and depiction of elements in the drawings may be exaggerated for clarity, illustration, and convenience.

### DETAILED DESCRIPTION

The advantages and features of the present invention, and the manner of achieving them, will become apparent from the following detailed description of exemplary embodiments with reference to the accompanying drawings. It should be understood, however, that the present invention is not limited to the disclosed embodiments but may be implemented in various other forms. Rather, the disclosed embodiments are provided to fully convey the scope of the invention to those skilled in the art and to enable them to practice the invention. The scope of the invention is defined solely by the appended claims.

The following provides a brief explanation of the terms used herein, followed by a detailed description of the present invention.

The terms used in the present invention have been selected as commonly used general terms to the extent possible, taking into account their functions within the invention. However, such terms may vary depending on the intent of those skilled in the art, precedents, or the emergence of new technologies. In certain cases, terms have been arbitrarily selected by the applicant, and in such instances, their meanings will be described in detail in the specification. Accordingly, the terms used herein should not be construed as mere labels but interpreted based on their meanings and the context of the present invention as a whole.

Throughout this specification, when a component is described as “including” another component, it is to be understood that, unless expressly stated otherwise, such description does not exclude the presence of additional components. Furthermore, the terms such as “unit,” “module,” and “part” used herein refer to elements that process at least one function or operation, and may be implemented as hardware components such as software, field-programmable gate arrays (FPGAs), application-specific integrated circuits (ASICs), or combinations of software and hardware. However, these terms are not limited to software or hardware implementations. For example, a “unit,” “module,” or “part” may be embodied as software components, object-oriented software components, class components, and task components; as processes, functions, attributes, procedures, subroutines, segments of program code, drivers, firmware, microcode, circuits, data, databases, data structures, tables, arrays, and variables; or may be implemented in a computer-readable medium and configured to be executed by one or more processors.

Hereinafter, exemplary embodiments of the present invention will be described in detail with reference to the accompanying drawings so that those skilled in the art may readily implement the invention. For clarity of explanation, portions not relevant to the description of the invention are omitted from the drawings.

The terms such as “first,” “second,” and the like may be used to describe various components, but such terms should not be construed as limiting the components. These terms are used merely to distinguish one component from another. For example, without departing from the scope of the present invention, a “first” component may be referred to as a “second” component, and similarly, a “second” component may be referred to as a “first” component. The term “and/or” as used herein includes any and all combinations of one or more of the associated listed items.

It should be understood that, as used herein, the singular forms “a,” “an,” and “the” include plural referents unless the context clearly dictates otherwise. Accordingly, the terms “a target policy,” “an imitation policy,” and similar expressions encompass both singular and plural forms.

Hereinafter, an embodiment of a method for generating a Pareto policy set, a device for generating Pareto policy set, and a central server for generating a Pareto policy set will be described with reference to the accompanying drawings.

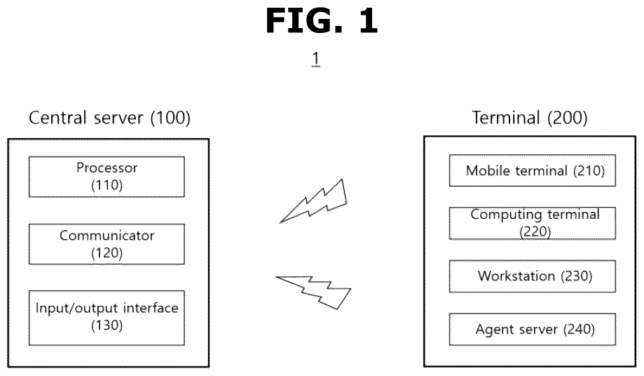

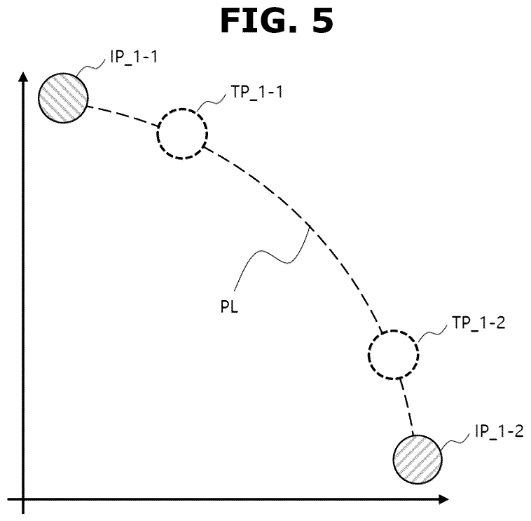

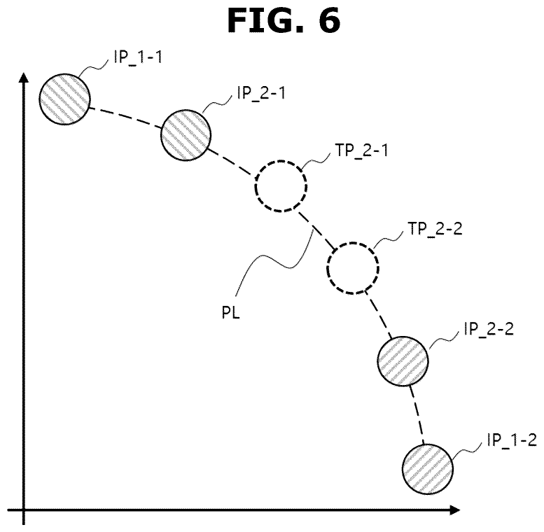

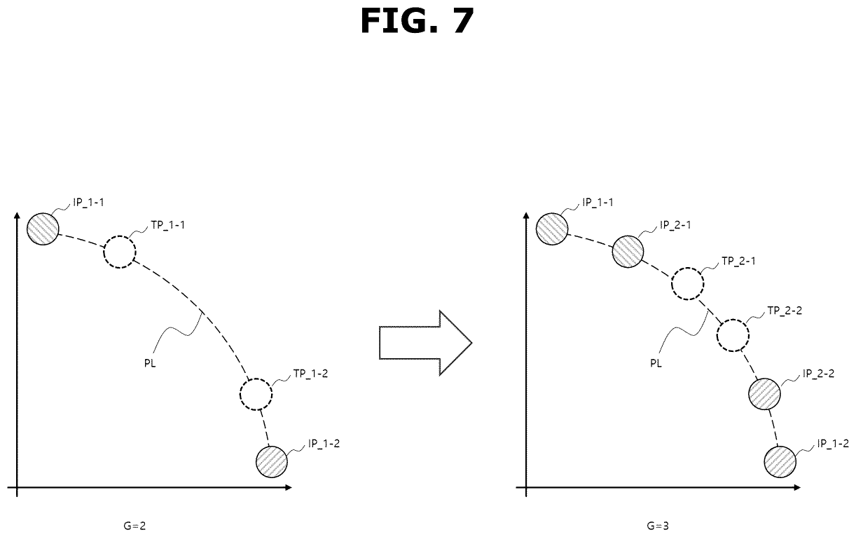

Hereinafter, an embodiment of a device for generating Pareto policy set and a central server for generating a Pareto policy set will be described with reference to FIGS. 1 to 9.

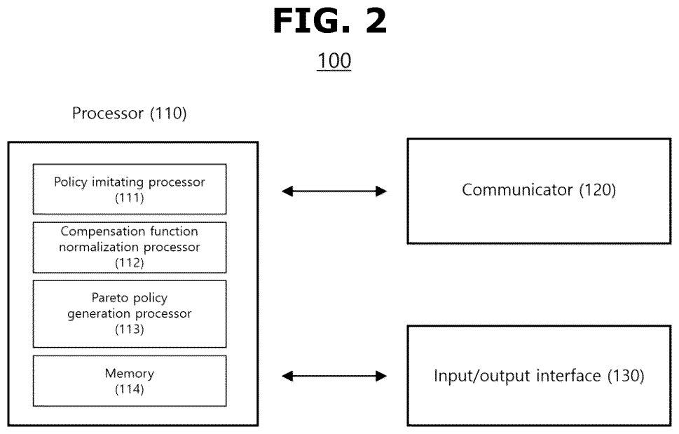

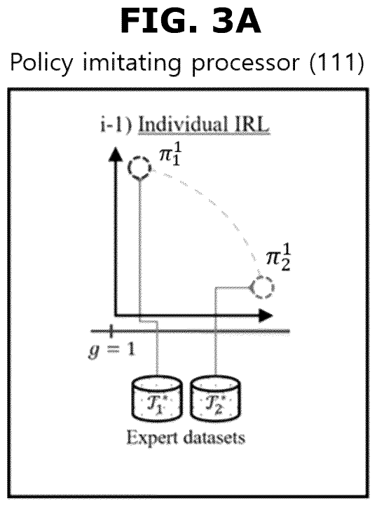

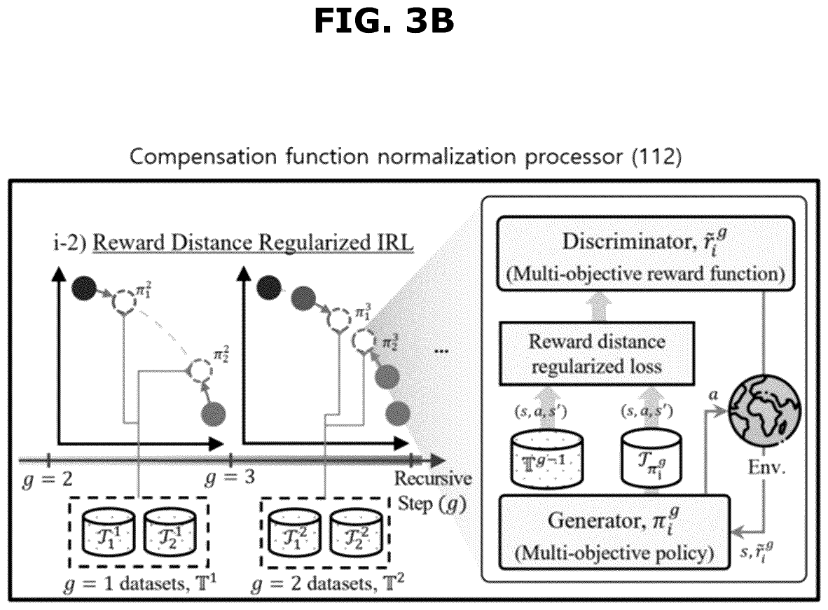

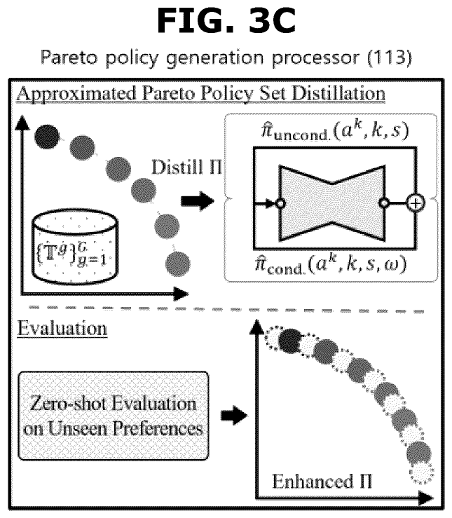

FIG. 1 is a block diagram of a device for generating a Pareto policy set according to an embodiment, FIG. 2 is a block diagram of a central server according to an embodiment, and FIGS. 3A to 3C are block diagrams of a processor according to an embodiment.

Referring to FIG. 1, the device 1 for generating a Pareto policy set may include a central server 100 and a terminal 200.

The terminal 200 may receive a sample dataset for generating a multi-objective Pareto policy set from a user, and the terminal 200 may include a mobile terminal 210, a computing terminal 220, a workstation 230, and an agent server 240.

The central server 100 may generate an imitation policy through inverse reinforcement learning based on the sample dataset, generate a target policy approximating the generated imitation policy by normalizing it through inverse reinforcement learning, and generate a Pareto policy set by combining the generated imitation policy and the target policy. The central server 100 may include a processor 110, a communicator 120, and an input/output interface 130.

The communication unit 120 may receive a user's input sample dataset from the terminal 200. The communicator 120 may be implemented using, for example, at least one communication module (e.g., a LAN card, a short-range communication module, a mobile communication module, or the like).

The input/output interface 130 may provide the user to directly input the sample dataset to the central server 100 without the communicator 120 receiving the sample dataset from the terminal 200. The input/output interface 130 may include an input unit and an output unit.

The input/output interface 130 may be in the form of pressing an operation button in the form of a push button, may manipulate the operation of the device 1 for generating a Pareto policy set desired by the user and the central server 100 for generating a Pareto policy set, such as a slide switch, or may input an operation desired by the user in the form of a touch. In addition, various types of input devices for inputting the operation of the device 1 for generating a Pareto policy set and the central server 100 for generating the Pareto policy set desired by the user may be used as an example of the input unit.

For example, the input/output interface 130 may include a display. The display may be a Cathode Ray Tube (CRT), a Digital Light Processing (DLP) panel, a plasma display panel, a Liquid Crystal Display (LCD) panel, an Electro Luminescence (EL) panel, an Electrophoretic Display (EPD) panel, an Electrochromic Display (ECD) panel, a Light Emitting Diode (LED) panel, or an Organic Light Emitting Diode (OLED) panel, but is not limited thereto. In addition, the output unit may include a Central Processing Unit (CPU), a Graphic Processing Unit (GPU), and various types of storage devices implemented as a microprocessor, and the like, and such devices may be provided on a Printed Circuit Board (PCB) embedded therein.

The processor 110 may receive the sample dataset, generate and fine-tune the target policy, and generate a Pareto policy set. Here, the target policy may mean a Pareto policy, and the Pareto policy means a policy that compromises in a multi-objective policy. Specifically, when there is a objective of A and a objective of B, it means a policy derived when each objective is maximized, and a combination of these means a Pareto policy set.

The processor 110 may include, for example, a Central Processing Unit (CPU), a Graphic Processing Unit (GPU), a Micro Controller Unit (MCU), an Application Processor (AP), an Electronic Controlling Unit (ECU), and/or at least one electronic device capable of performing various operations and control processing. These devices may be implemented, for example, by using one or two or more semiconductor chips, circuits, or related components alone or in combination.

The processor 110 may derive a reward function through multi-objective target reinforcement learning (Multi-objective RL, MORL). Specifically, the multi-objective Markov determination processes Markov decision process (MOMDP) may be configured as Equation 1 with various reward functions related to different goals.

$$( S , A , P , r , Ω , f , γ ) \qquad [ Equation 1 ]$$

Here, s∈S denotes a state space, a∈A denotes an action space, P:S×A×S→[0,1] denotes a transition probability, and γ∈[0,1] denotes a discount factor. MOMDP contains m reward function vectors, r=[r₁, . . . , rₘ], which are defined as r:S×A×S→R·Ω⊂R^{m} denotes a set of preference vectors, and f(r,ω)=ω^{T} denotes a linear preference function when ω∈Ω. The goal of MORL is to find a Pareto policy set (π*∈Π*) that maximizes scalarized reward as shown in Equation 2 in the MOMDP environment.

$${max}_{π} {E}_{α ∼ π ( \cdot \vert s )} [ {\sum }_{t = 1}^{H} {γ}^{t} f ( r , w ) ] \qquad [ Equation 2 ]$$

The process may generate an imitation policy and a target policy through inverse reinforcement learning (Inverse RL, IRL). Here, in the inverse reinforcement learning, each trajectory Tᵢ appears as a sequence of states and behavior pairs

$${\{ ( {s}_{t} , {a}_{t} ) \}}_{t = 1}^{T}$$

given an expert sample dataset

$$T *= {\{ {T}_{i} \}}_{i = 1}^{n} .$$

The objective of the IRL is to infer the reward function of expert policy, enabling the rationalization of its behavior. Among various methods, the adversarial IRL algorithm (AIRL) may convert IRL into a discriminator as shown in Equation 3 as a generative adversarial problem.

$$D ( s , a , {s}^{′} ) = \frac{exp ( \tilde{r} ( s , a , {s}^{′} )}{exp ( \tilde{r} ( s , a , {s}^{′} ) ) + π ( a \vert s )} \qquad [ Equation 3 ]$$

Here, s′˜P(s, α, ·) is an inferred reward function. The discriminator is trained as shown in Equation 4 to maximize the cross entropy between the expert sample dataset and the dataset induced by policy.

$$max [ {E}_{( s , a ) ∼ {T}_{π}} [ log ( 1 - D ( s , a , {s}^{′} ) ) ] + {E}_{( s , a ) ∼ T *} [ log ( D ( s , a , {s}^{′} ) ) ] ] \qquad [ Equation 4 ]$$

Here, T_{π} means the dataset induced by the learning policy π. The generator of AIRL corresponds to π, which is trained as in Equation 5 to maximize the entropy normalized reward function.

$$log ( D ( s , a , {s}^{′} ) ) - log ( 1 - D ( s , a , {s}^{′} ) ) = \tilde{r} ( s , a , {s}^{′} ) - log π ( a \vert s ) \qquad [ Equation 5 ]$$

The present invention specifically embodies the Pareto IRL problem of deriving a Pareto policy set from a strictly limited dataset. Given M different datasets

$$T *= {\{ {T}_{i}^{*} \}}_{i = 1}^{M} ,$$

each dataset

$${r}_{mo} = {ω}_{i}^{T} R$$

is collected from an optimal policy for a reward function

$${T}_{i}^{*}$$

with a fixed preference ωᵢ∈Ω. In addition, it is assumed that each dataset Tᵢ* clearly shows dominance over a specific reward function rᵢ.

In the present invention, two target scenarios (M=2) are considered, and the IRL framework is designed by assuming a generalized situation for three or more targets later. Given two different datasets, Pareto IRL is the derived Pareto policy set in the context of IRL. Specifically, it aims to infer the reward function \tilde{r} for all preferences ω from the limited sample dataset T* and to learn the policy π. In other words, when utilizing a limited expert sample dataset in a multi-objective environment, the focus is on effectively building a Pareto policy set for unknown reward functions and preferences.

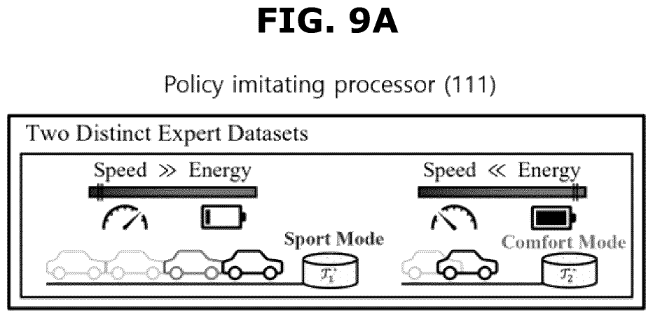

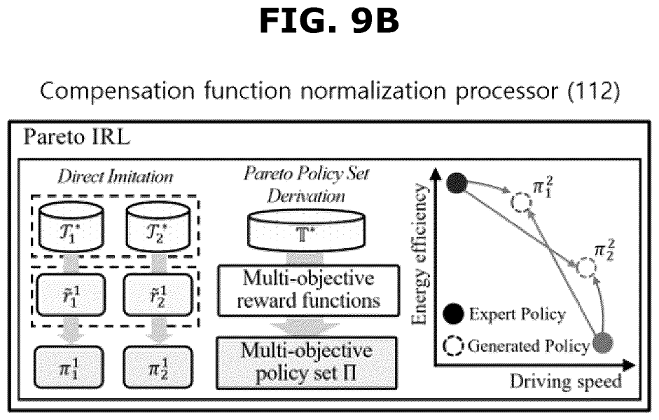

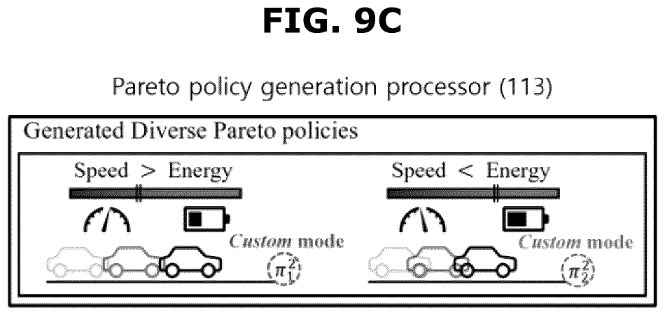

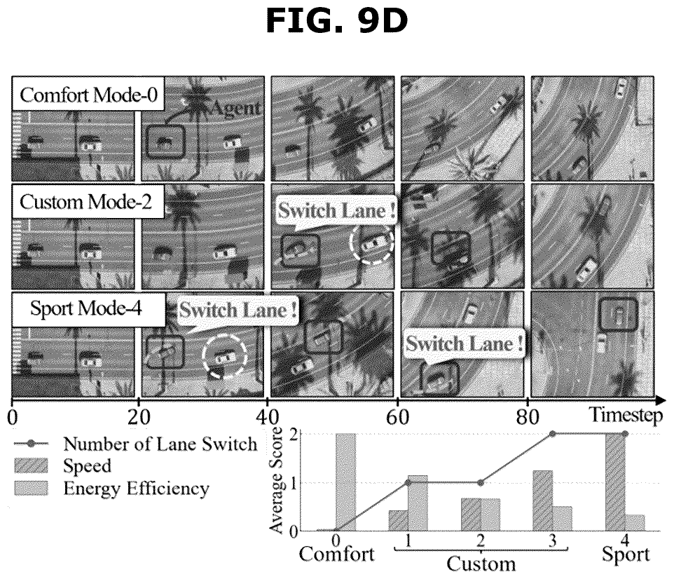

In FIGS. 9A to 9D, which briefly describe the concept of Pareto IRL indicating the generation of the Pareto policy set, the autonomous driving operation includes different preferences for two goals such as driving speed and energy efficiency. For example, consider a situation where two different expert sample datasets

$${T}_{1}^{*} and {T}_{2}^{*}$$

each contain a different dominant objective. Although it is possible to restore a single useful policy from a given expert sample dataset, the present invention aims to solve the problem of generating a policy set covering a wider range of preferences beyond the given dataset. These policies may provide optimal compromise return, allowing users to immediately select the optimal solution according to their preferences and circumstances.

When MOMDP has a preference vector ω∈Ω, a reward function vector r, and a preference function f, a multi-objective policy set is found through generation of a Pareto policy set as shown in Equation 6.

$$\prod = \{ π \vert {R}_{f ( r , ω )} ( π ) \geq {R}_{f ( r , ω )} ( {π}^{′} ) , {∀}_{π}^{′} , ∃ ω ∈ Ω \} \qquad [ Equation 6 ]$$

The M expert preference sample dataset

$$T *= {\{ {T}_{i}^{*} \}}_{i = 1}^{M}$$

is given here. Rᵣ(π) represents the return induced by the policy π for the reward function r. The actual reward function r of the vector is not explicitly revealed, and may be an IRL scenario in which a reward signal is not given in the expert sample dataset.

The processor 110 may start by directly imitating a given sample dataset, and then recursively find a new adjacent policy located at the Pareto front. Specifically, the process may learn a robust multi-objective reward function by adopting a reward distance normalization IRL method that integrates reward distance normalization into the objective of the discriminator. This normalized IRL ensures that the performance of the policy learned by the inferred multi-objective reward function remains within the performance of the policy learned by the actual reward function. It is repeatedly performed to achieve new and useful policies that do not exist in the expert dataset to build a high-quality Pareto policy set.

The process can distil the Pareto policy set into a preference condition diffusion model. The diffusion model may include both conditional and non-conditional policies according to each preference. The preference condition diffusion model may include both preference condition knowledge within a specific preference and task condition knowledge across all preferences. As a result, the integrated policy model provides strong performance for invisible preferences, and may enable efficient resource utilization with a single policy network.

The processor 110 may include a policy imitation processor 111, a reward function normalization processor 112, a Pareto policy generation processor 113, and a memory 114.

The policy imitation processor 111 may receive the sample dataset and generate an imitation policy by imitating a multi-objective policy through inverse reinforcement learning. Specifically, as shown in FIGS. 3A to 3C, the policy imitation processor 111 may perform two separate inverse reinforcement learning (IRL) processes for directly imitating each sample dataset. Specifically, the policy imitation processor 111 may infer two reward functions

$${\{ {\tilde{r}}_{i}^{1} \}}_{i = 1}^{2}$$

and two imitating policies

$${\{ {π}_{i}^{1} \}}_{i = 1}^{2}$$

from two Individual sample datasets

$${T}_{i}^{*} ∈ T *$$

using an adversarial IRL algorithm (AIRL).

As illustrated in FIGS. 3A to 7, the reward function normalization processor 112 may generate and fine-tune the target policy based on the imitation policy and the reward function generated by the policy imitation processor 111. Specifically, the reward function normalization processor 112 may generate the target policy by equally positioning the imitation policy at a predetermined position near each of the two imitation policies. Here, the predetermined position may be located on the predetermined Pareto front PL, which is a curve extending between the two imitation policies, and the predetermined Pareto front PL and the predetermined position may be variables predetermined by the designer. The reward function normalization processor 112 may fine tune the target policy based on a distance between a reward function of two imitation policies (a reward function of the first imitation policy IP_1-1 and a reward function of the second imitation policy IP_1-2) and a reward function of two target policies (a reward function of the first target policy TP_1-1 and a reward function of the second target policy TP_1-2). Specifically, the reward function normalization processor 112 may fine-tune the first target policy TP_1-1 based on a distance between the reward function of the first imitation policy IP_1-1 and the reward function of the first target policy TP_1-1, a distance between the reward function of the second imitation policy IP_1-2 and the reward function of the first target policy TP_1-1, and a distance between the reward function of the first imitation policy IP_1-1 and the reward function of the second imitation policy IP_1-2. In addition, the reward function normalization processor 112 may fine-tune the second target policy TP_1-2 based on a distance between the reward function of the first imitation policy IP_1-1 and the reward function of the second target policy TP_1-2, a distance between the reward function of the second imitation policy IP_1-2 and the reward function of the second target policy TP_1-2, and a distance between the reward function of the first imitation policy IP_1-1 and the reward function of the second imitation policy IP_1-2. The reward function normalization processor 112 may generate a normalization term based on the distance between the reward functions of the target policy and the distance between the reward functions of the imitation policy, and learn to maximize the reward function normalization equation including the generated normalization term to fine-tune the target policy. A specific algorithm for fine-tuning the target policy by learning the reward function normalization processor 112 to maximize the normalization term and the reward function normalization equation for fine-tuning will be described later.

As illustrated in FIGS. 3A to 7, when the fine-tuned reward function of the first target policy TP_1-1 and the fine-tuned reward function of the second target policy TP_1-2 are adjacent to each other, the reward function normalization processor 112 transmits the imitation policy and the target policy to the Pareto policy generation processor 113 to generate the Pareto policy set. However, when the reward function of the fine-tuned first target policy TP_1-1 and the reward function of the second target policy TP_1-2 are not adjacent to each other, the reward function normalization processor 112 may update the fine-tuned target policy to an imitation function to generate an additional multi-objective target policy. Specifically, the reward function normalization processor 112 may generate a Pareto policy set when the distance between the reward function of the first target policy TP_1-1 and the reward function of the second target policy TP_1-2 is less than or equal to the predetermined distance, and may change the first target policy TP_1-1 to the third imitation policy IP_2-1 and the second target policy TP_1-2 to the fourth target policy TP_2-2 by updating the first target policy TP_1-1 and the second target policy TP_1-2 to the imitation policy when the distance between the reward function of the first target policy TP_1-1 and the reward function of the second target policy TP_1-2 exceeds the predetermined distance.

As illustrated in FIGS. 3A to 7, the reward function normalization processor 112 may assume the above-described normalization order of the target policy normalization process as the second order (G=2), and may perform the target policy normalization of the third order (G=3) normalization order. Specifically, the reward function normalization processor 112 may generate the third target policy TP_2-1 and the fourth target policy TP_2-2 at a predetermined position on the Pareto front PL, which is predetermined between the third imitation policy IP_2-1 and the fourth imitation policy IP_2-2. The reward function normalization processor 112 may be configured to: a distance between a reward function of the first imitation policy IP_1-1 and a reward function of the third target policy TP_2-1, a distance between a reward function of the second imitation policy IP_1-2 and a reward function of the third target policy TP_2-1, a distance between a reward function of the third imitation policy IP_2-1 and a reward function of the third target policy TP_2-1, a distance between a reward function of the fourth imitation policy IP_2-2 and a reward function of the third target policy TP_2-1, a reward function of four imitation policies (the first imitation policy IP_1-1), a reward function of the second imitation policy IP_1-2 The third target policy TP_2-1 may be fine-tuned based on the distance between the reward function of the third imitation policy IP_2-1 and the reward function of the fourth imitation policy IP_2-2. The reward function normalization processor 112 may be configured to: a distance between a reward function of the first imitation policy IP_1-1 and a reward function of the fourth target policy TP_2-2, a distance between a reward function of the second imitation policy IP_1-2 and a reward function of the fourth target policy TP_2-2, a distance between a reward function of the third imitation policy IP_2-1 and a reward function of the fourth target policy TP_2-2, a distance between a reward function of the fourth imitation policy IP_2-2 and a reward function of the fourth target policy TP_2-2, a reward function of four imitation policies (the first imitation policy IP_1-1), a reward function of the second imitation policy IP_1-2 The fourth target policy TP_2-2 may be fine-tuned based on the respective distances of the reward function of the third imitation policy IP_2-1 and the reward function of the fourth imitation policy IP_2-2.

As illustrated in FIGS. 3A to 7, thereafter, when the fine-tuned reward function of the third target policy TP_2-1 and the fine-tuned reward function of the fourth target policy TP_2-2 are adjacent to each other, the reward function normalization processor 112 transmits the imitation policy and the target policy to the Pareto policy generation processor 113 to generate the Pareto policy set. However, when the fine-tuned reward function of the third target policy TP_2-1 and the fine-tuned reward function of the fourth target policy TP_2-2 are not adjacent to each other, the reward function normalization processor 112 may update the fine-tuned target policy to an imitation function to generate an additional multi-objective target policy. Specifically, the reward function normalization processor 112 may generate a Pareto policy set when the distance between the reward function of the third target policy TP_2-1 and the reward function of the fourth target policy TP_2-2 is less than or equal to the predetermined distance, and may change the third target policy TP_2-1 to the fifth imitation policy and the fourth target policy TP_2-2 to the sixth target policy by updating the third target policy TP_2-1 and the fourth target policy TP_2-2 to the imitation policy when the distance between the reward function of the third target policy TP_2-1 and the reward function of the fourth target policy TP_2-2 exceeds the predetermined distance. The reward function normalization processor 112 may repeatedly proceed with the above-described order of the target policy normalization process. A detailed description of the target policy normalization process of the reward function normalization processor 112 will be described later.

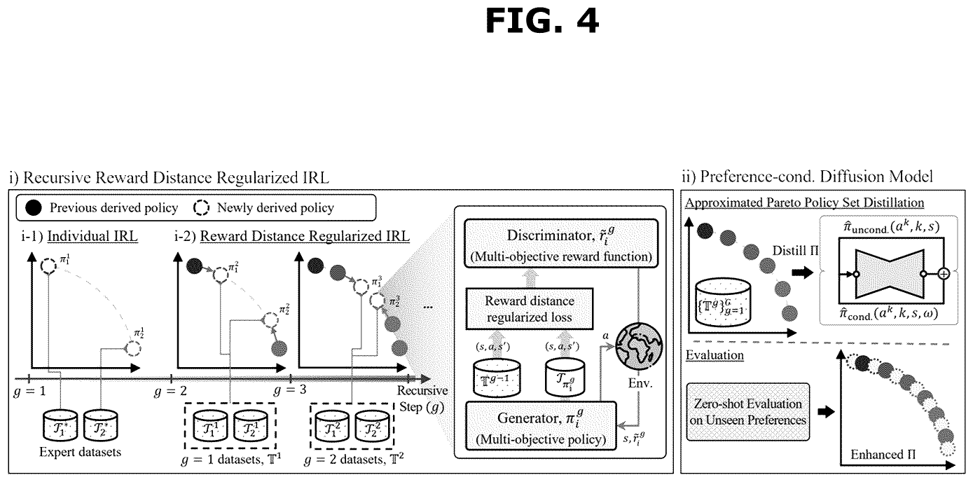

As shown in FIG. 4(i-2), the reward function normalization processor 112 may derive a policy

$${\{ {π}_{i}^{g} \}}_{i = 1}^{2}$$

related to a multi-objective reward function

$${\{ {\tilde{r}}_{i}^{g} \}}_{i = 1}^{2}$$

beyond the sample dataset given in each recursive step g≥2. To this end, a simple approach can be used to repeatedly perform IRL by mixing expert sample datasets in various ratios. However, these consequential policies do not adequately explore non-dominant optimal behavior beyond the simple interpolation of existing behavior and tend to converge to the weighted average of the dataset.

To solve this problem, the reward function normalization processor 112 calculates the distance between the reward function

$${\tilde{r}}^{g - 1} = [ {\tilde{r}}_{1}^{g - 1} , {\tilde{r}}_{2}^{g - 1} ]$$

derived in the previous step and the newly derived reward function

$${\tilde{r}}_{i}^{g}$$

using the reward distance metric d(r, r′). In addition, a vector

$${ϵ}_{i}^{g} = [ {ϵ}_{i , 1}^{g} , {ϵ}_{i , 2}^{g} ]$$

of each corresponding measured reward distance is defined, and a reward distance normalization term is defined as in Equation 7.

$$I ( {\tilde{r}}_{i}^{g} , {\tilde{r}}^{g - 1} ) = {\sum }_{j = 1}^{e} {( {ϵ}_{i , 1}^{g} - d ( {\tilde{r}}_{i}^{g} , {\tilde{r}}_{i}^{g - 1} ) )}^{2} \qquad [ Equation 7 ]$$

Then, Equation 8 is derived by applying Equation 7 to Equation 4 for the discriminator objective.

$$max [ {E}_{( s , a ) ∼ {T}_{{π}_{i}^{g}}} [ log ( 1 - D ( s , a , {s}^{′} ) ) ] + {E}_{( s , a ) ∼ {T}_{g - 1}} [ log ( D ( s , a , {s}^{′} ) ) ] ] - β \cdot I ( {\tilde{r}}_{i}^{g} , {\tilde{r}}^{g - 1} ) \qquad [ Equation 8 ]$$

Here, β is a hyperparameter. This allows the discriminator to optimize the multi-objective reward function for a specific target distance between datasets. The reward distance normalization IRL procedure may be performed twice to derive a policy adjacent to the policy of the previous step. This can lead to new useful policies, which can achieve new useful policies that do not exist in the expert dataset.

The selection of the target distance by the reward function normalization processor 112 is important. Since the regret of the policy is limited by the reward distance, the sum of the target distances is set as small as possible. The reward function normalization processor 112 allocates a small constant value to one target distance, and determines the other as ϵgi-ϵgi,i. Through this, it is possible to effectively derive a new policy adjacent to one of the previous policies.

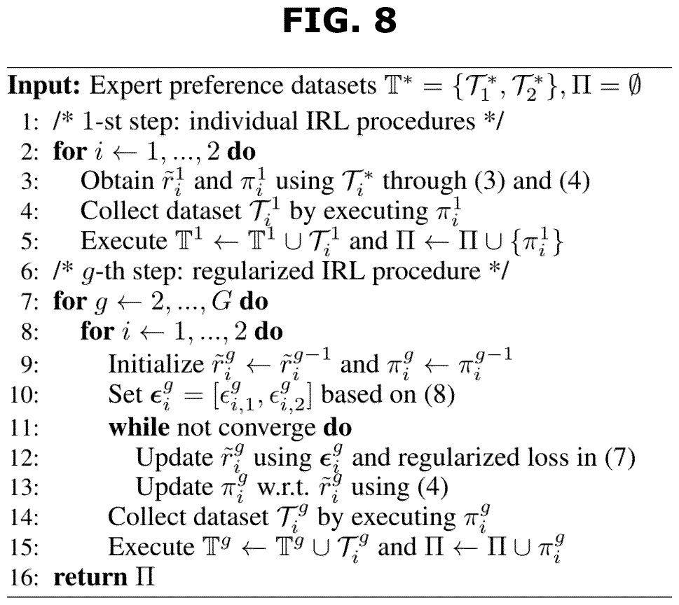

For ParIRL, a reward distance metric that guarantees a regret bound of a policy may be used. The reward function normalization processor 112 may quantitatively measure the distance between the two reward functions by adopting an equal policy invariance comparison similarity metric. The learning algorithm of the recursive reward distance normalization IRL is expressed in FIG. 8.

The reward function normalization processor 112 may analyze a regret bound of the reward distance normalized policy. It is assumed that \tilde{r} is a learned reward function and that the optimal policy for r is

$${π}_{r}^{*} .$$

It is assumed that there is rₘₒ=ω^{T}r a (actual) multi-objective reward function with preference ω=[<ω₁, ω₂]. Equation 9 may be derived through the linearity of rₘₒ.

$${R}_{{r}_{mo}} ( {π}_{{r}_{mo}}^{*} ) - {R}_{{r}_{mo}} ( {π}_{\tilde{r}}^{*} ) = {\sum }_{i = 1}^{2} {ω}_{i} ( {R}_{{\tilde{r}}_{i}} ( {π}_{{r}_{mo}}^{*} ) - {R}_{{\tilde{r}}_{i}} ( {π}_{\tilde{r}}^{*} ) ) \leq {\sum }_{i = 1}^{2} {ω}_{i} ( {R}_{{\tilde{r}}_{i}} ( {π}_{{\tilde{r}}_{i}}^{*} ) - {R}_{{\tilde{r}}_{i}} ( {π}_{\tilde{r}}^{*} ) ) \qquad [ Equation 9 ]$$

The distribution D is used to calculate the EPIC distance d_{ϵ}, where the distribution D_{π,t} is the transition distribution at the time point t induced by the policy π. It can be derived that Equation 9 is limited to the sum of the individual regret bounds. That is, it may be derived as in Equation 10.

$${\sum }_{i = 1}^{2} {ω}_{i} ( {R}_{{\tilde{r}}_{i}} ( {π}_{{\tilde{r}}_{i}}^{*} ) - {R}_{{\tilde{r}}_{i}} ( {π}_{\tilde{r}}^{*} ) ) \leq {\sum }_{i = 1}^{2} 16 {ω}_{i} {‖ {\tilde{r}}_{i} ‖}_{2} ( {Kd}_{ϵ} ( \tilde{r} , {\tilde{r}}_{i} ) + L {Δ}_{α} ( \tilde{r} ) ) \qquad [ Equation 10 ]$$

A regret bound of the policy π for the learned reward function \tilde{r} of the reward function normalization processor 112 is expressed by Equation 11.

$${R}_{{r}_{mo}} ( {π}_{{r}_{mo}}^{*} ) - {R}_{{r}_{mo}} ( {π}_{\tilde{r}}^{*} ) \leq 32 K {‖ {r}_{mo} ‖}_{2} ( {\sum }_{i = 1}^{2} [ {ω}_{i} {d}_{ϵ} ( \tilde{r} , {\tilde{r}}_{i} ) ] + \frac{L}{K} ) {Δ}_{α} ( \tilde{r} ) \qquad [ Equation 11 ]$$

The regret bound of the policy π for the trained reward function \tilde{r} of the reward function normalization processor 112 is represented by the difference between the normalization term based on EPIC and the transition distribution generated by the policy π*\tilde{r} and the distribution D used to calculate the EPIC distance. This ensures that it can be directly optimized using Equation 8. Instead of directly multiplying the preference w by the loss function, the reward function normalization processor 112 may reformat the target distance to better balance the distance.

The Pareto policy generation processor 113 may set the imitation policy and the target policy as each Pareto policy and combine them to generate a Pareto policy set. The Pareto policy generation processor 113 may derive a zero-shot performance of distilling the generated Pareto policy set into a single diffusion model to generate policies not considered when generating the Pareto policy without learning. A detailed description will be made below.

In order to further improve the Pareto policy set Π, the Pareto policy generation processor 113 may interpolate and extrapolate the policy using a diffusion model. The Pareto policy generation processor 113 systematically annotates Π with preference ω∈Ω, and learns a diffusion-based policy model that is conditionally trained with this preference.

$${π}_{u} ( a \vert s , ω ) = N ( {a}^{K} ; 0 , I ) {\prod }_{k = 1}^{K} {\hat{π}}_{u} ( {a}^{k - 1} \vert {a}^{k} , k , s , ω ) \qquad [ Equation 12 ]$$

Here, the superscript k˜[1, K] indicates the denoising time point, α⁰(=α) is the original behavior, and α^{k-1} is the denoised version of α^{k}. The diffusion model was designed to predict the noise in α^{k}=\vec{α̅kα}+\vec{1−α̅^{k}η}along with the dispersion constant parameters of α̅^{k} and η˜N(0, I).

$$min {𝔼}_{( s , a ) \sim {\{ {𝕋}^{g} \}}_{g = 1}^{G} , k \sim [ 1 , K ]} [ {‖ {\hat{π}}_{u} ( {a}^{k} , k , s , ω ) - η ‖}_{2}^{2} ] \qquad [ Equation 13 ]$$

Here,

$${\{ {T}^{g} \}}_{g = 1}^{G}$$

is the entire dataset collected by Π's policy. In addition, the Pareto policy generator 113 expresses the model as a combination of preference conditional and non-conditional policies.

$${\hat{π}}_{u} ( {a}^{k} , k , s , ω ) := ( 1 - δ ) {\hat{π}}_{cond .} ( {a}^{k} , k , s , ω ) + δ {\hat{π}}_{uncond .} ( {a}^{k} , k , s ) \qquad [ Equation 14 ]$$

Here, δ is the derived weight. The unconditional policy includes general knowledge throughout the estimated Pareto policy, and the conditional policy guides behavior according to specific preferences.

During sampling, the policy begins with random noise and repeatedly denoises to obtain viable behavior.

$${a}^{k - 1} = \frac{1}{\sqrt{{a}^{k}}} ( {a}^{k} - \frac{1 - {a}^{k}}{\sqrt{1 - {\overline{a}}^{k}}} {\hat{π}}_{u} ( {a}^{k} , k , s , ω ) ) + {σ}^{k} η \qquad [ Equation 15 ]$$

Here, α^{k} and σ^{k} a constant variance parameter. The diffusion model \hat{π}ᵤ enables efficient resource utilization with a single policy network and provides strong performance for invisible preferences. Consequently, this may improve the Pareto policy set in terms of the density of the Pareto policy set.

The memory 114 may store data necessary for an operation in the device 1 for generating a Pareto policy set. The memory 114 may store a sample dataset, a predetermined distance, a predetermined location, a predetermined Pareto front PL, an imitation policy, a reward function of an imitation policy, a target policy, a reward function of a target policy, and a Pareto policy set.

The memory 114 may include at least one of a main memory device and an auxiliary memory device. For example, the main memory device may be implemented using a semiconductor storage medium such as a ROM and/or a RAM, and the auxiliary memory device may be implemented based on a device capable of permanently or semi-permanently storing data, such as a flash memory 114 device (a Solid State Drive (SSD) etc.), a Secure Digital (SD) card, a HDD (Hard Disc Drive), a compact disk, a DVD, or a laser disk.

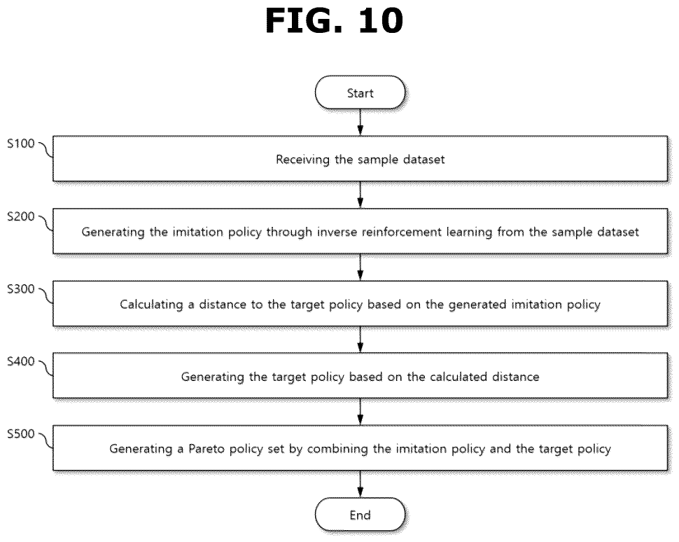

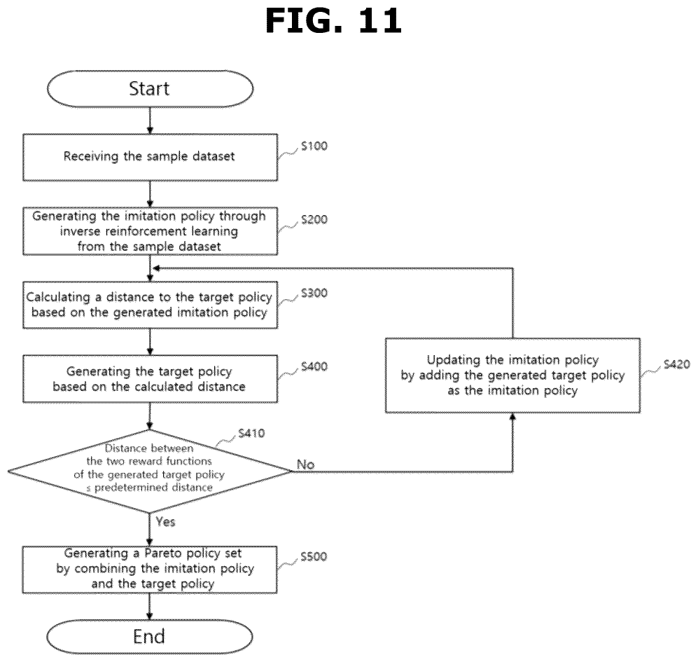

Hereinafter, an embodiment of a method for generating a Pareto policy set will be described with reference to FIGS. 10 and 11.

FIG. 10 is a flowchart of a method for generating a Pareto policy set according to an embodiment, and FIG. 11 is a flowchart of a method of generating a Pareto policy set according to another embodiment.

According to an embodiment of the method for generating a Pareto policy set, the input/output interface may receive the sample dataset (S100), and the processor may generate the imitation policy through inverse reinforcement learning from the sample dataset (S200). Thereafter, the processor may calculate a distance to the target policy based on the generated imitation policy (S300), and may generate the target policy based on the calculated distance (S400). Thereafter, the processor may generate a Pareto policy set by combining the imitation policy and the target policy (S500).

According to another embodiment of the method for generating a Pareto policy set, the input/output interface may receive the sample dataset (S100), and the processor may generate the imitation policy through inverse reinforcement learning from the sample dataset (S200). Thereafter, the processor may calculate a distance to the target policy based on the generated imitation policy (S300), and may generate the target policy based on the calculated distance (S400). Thereafter, when the distance between the two reward functions of the generated target policy exceeds the predetermined distance by comparing the distance with the predetermined distance (S410), the processor may update the imitation policy by adding the generated target policy as the imitation policy (S420), and repeatedly perform steps S300 to S410. In addition, when the distance between the two reward functions of the generated target policy is equal to or less than the predetermined distance compared to the predetermined distance, the processor may generate the Pareto policy set by combining the imitation policy and the target policy (S500).

Those skilled in the art will recognize that various modifications and variations can be made to the embodiments described herein without departing from the essential characteristics of the invention. Therefore, the disclosed methods should be considered illustrative rather than restrictive. The scope of the invention is defined by the appended claims, and all modifications, equivalents, and variations falling within the scope of the claims are intended to be encompassed thereby.

What is claimed is:

1. A method for generating a Pareto policy set, the method comprising:
receiving a sample dataset;
generating an imitation policy and a reward function of the imitation policy from the sample dataset;
setting a target policy at a predetermined position near the imitation policy;
fine-tuning the target policy based on a distance between the reward function of the imitation policy and the reward function of the target policy; and
generating a Pareto policy set including the imitation policy and the fine-tuned target policy.

2. The method for generating a Pareto policy set of claim 1,
wherein the generating an imitation policy and a reward function of the imitation policy comprises generating two imitation policies and two reward functions of the imitation policies, respectively, from each of the two sample datasets, and
wherein the setting a target policy comprises generating two target policies.

3. The method for generating a Pareto policy set of claim 1,
wherein the imitation policy comprises a first imitation policy and a second imitation policy and the reward function of the imitation policy comprises a reward function of the first imitation policy and a reward function of the second imitation policy, and
wherein the fine-tuning the target policy comprises fine-tuning the target policy based on a distance between the reward function of the first imitation policy and the reward function of the target policy.

4. The method for generating a Pareto policy set of claim 1,
wherein the imitation policy comprises a first imitation policy and a second imitation policy and the reward function of the imitation policy comprises a reward function of the first imitation policy and a reward function of the second imitation policy, and
wherein the fine-tuning the target policy comprises fine-tuning the target policy based on a distance between the reward function of the second imitation policy and the reward function of the target policy.

5. The method for generating a Pareto policy set of claim 1,
wherein the imitation policy comprises a first imitation policy and a second imitation policy and a reward function of the imitation policy comprises a reward function of the first imitation policy and a reward function of the second imitation policy, and
wherein the fine-tuning the target policy comprises fine-tuning the target policy based on a distance between the reward function of the first imitation policy and the reward function of the second imitation policy.

6. The method for generating a Pareto policy set of claim 1,
wherein the fine-tuning the target policy comprises generating a normalization term based on a distance between a reward function of the imitation policy and a reward function of the target policy and a distance between reward functions of the imitation policy, and fine-tuning the target policy by learning to maximize a reward function normalization equation including the generated normalization term.

7. The method for generating a Pareto policy set of claim 1,
wherein in the setting a target policy, the predetermined position is located on a predetermined Pareto front extending between the imitation policies.

8. The method for generating a Pareto policy set of claim 1, further comprising:
updating the fine-tuned target policies to the imitation policies when the distance between the reward functions of the fine-tuned target policies exceeds a predetermined distance.

9. The method for generating a Pareto policy set of claim 1,
wherein the generating a Pareto policy set comprises generating the Pareto policy set when a distance between reward functions of the fine-tuned target policies is equal to or less than a predetermined distance.

10. The method for generating a Pareto policy set of claim 1,
wherein the generating an imitation policy and a reward function of the imitation policy and the fine-tuning of the target policy are performed based on inverse reinforcement learning.

11. A device for generating a Pareto policy set comprising:
an input/output interface configured to receive a sample dataset; and
a processor configured to generate a Pareto policy set based on the sample dataset;
wherein the processor is configured to generate an imitation policy and a reward function of the imitation policy from the sample dataset, set a target policy at a predetermined position adjacent to the imitation policy, fine-tune the target policy based on a distance between the reward function of the imitation policy and the reward function of the target policy, and generate a Pareto policy set including the imitation policy and the fine-tuned target policy.

12. The device for generating a Pareto policy set of claim 11,
wherein the imitation policy includes a first imitation policy and a second imitation policy,
wherein the reward function includes a reward function of the first imitation policy and a reward function of the second imitation policy, and
wherein the processor is further configured to fine-tune the target policy based on a distance between the reward function of the first imitation policy and the reward function of the target policy.

13. The device for generating a Pareto policy set of claim 11,
wherein the imitation policy includes a first imitation policy and a second imitation policy,
wherein the reward function includes a reward function of the first imitation policy and a reward function of the second imitation policy, and
wherein the processor is further configured to fine-tune the target policy based on a distance between the reward function of the second imitation policy and the reward function of the target policy.

14. The device for generating a Pareto policy set of claim 11,
wherein the imitation policy includes a first imitation policy and a second imitation policy,
wherein the reward function includes a reward function of the first imitation policy and a reward function of the second imitation policy, and
wherein the processor is further configured to fine-tune the target policy based on a distance between the reward function of the first imitation policy and the reward function of the second imitation policy.

15. The device for generating a Pareto policy set of claim 11,
wherein the processor is configured to generate a normalization term based on a distance between a reward function of the imitation policy and a reward function of the target policy and a distance between reward functions of the imitation policy, and fine-tune the target policy by learning to maximize a reward function normalization equation including the generated normalization term.

16. The device for generating a Pareto policy set of claim 11,
wherein the predetermined position is located on a predetermined Pareto front extending between the imitation policies.

17. The device for generating a Pareto policy set of claim 11,
wherein the processor is configured to update the fine-tuned target policies to the imitation policies when the distance between the reward functions of the fine-tuned target policies exceeds a predetermined distance.

18. The device for generating a Pareto policy set of claim 11,
wherein the processor is configured to generate the Pareto policy set when a distance between reward functions of the fine-tuned target policies is equal to or less than a predetermined distance.

19. The device for generating a Pareto policy set of claim 11,
wherein the processor is configured to generate an imitation policy and a reward function of the imitation policy and the fine-tune the target policy by performing inverse reinforcement learning.

20. A central server for generating a Pareto policy set, the central server comprising:
an input/output interface configured to receive a sample dataset; and
a processor configured to generate a Pareto policy set based on the sample dataset;
wherein the processor is configured to generate an imitation policy and a reward function of the imitation policy from the sample dataset, set a target policy at a predetermined position adjacent to the imitation policy, fine-tune the target policy based on a distance between the reward function of the imitation policy and the reward function of the target policy, and generate a Pareto policy set including the imitation policy and the fine-tuned target policy.
